(19) United States
(12) Patent Application Publication
(10) Pub. No.: US 2020/0039186 A1
(43) Pub. Date: Feb. 6, 2020

(54) GLASS SHEET PROCESSING METHOD AND GLASS SHEET PROCESSING MOLD

(71) Applicant: AAC Technologies Pte. Ltd., Singapore city (SG)

(72) Inventors: Yuqin Yuan, Shenzhen (CN); Xiaogang Zhai, Shenzhen (CN); Bo Xu, Shenzhen (CN); Wei Su, Shenzhen (CN)

(21) Appl. No.: 16/527,038

(22) Filed: Jul. 31, 2019

(30) Foreign Application Priority Data
Aug. 3, 2018 (CN) 201810882417.3

(51) Int. Cl. B32B 17/10; C03B 23/03

(52) U.S. Cl. CPC B32B 17/10036; C03B 2225/02; C03B 23/03

(57) ABSTRACT

The present disclosure a speaker box comprises a shell having a receiving space, a speaker unit accommodated in the receiving space, an acoustic channel formed in the receiving space, an auxiliary vocal cavity, a bezel and a cover plate. The speaker unit comprises a diaphragm for vibrating sound. The diaphragm separates the receiving space into a anterior vocal cavity and a posterior cavity, the acoustic channel connects the anterior vocal cavity with the outside world and forms the anterior cavity together with the anterior vocal cavity. The auxiliary vocal cavity is provided with the first pass connected with the anterior cavity and the second pass connected with the outside world, and the bezel is completely covered with the first pass and forms a fixed. The bezel is provided with a channel running through it, and the auxiliary vocal cavity is connected with the anterior cavity through the channel.

### FIELD OF THE DISCLOSURE

The present disclosure relates to product molding for glass substrate, and more particularly to a glass sheet processing method and a glass sheet processing mold.

### DESCRIPTION OF RELATED ART

With the development of the Internet era, electronic devices, such as mobile phones, tablet computers and notebook computers, are increasingly applied to people's daily life. People also have increasingly high requirements for appearance of the electronic devices in addition to functional requirements, and outer casings of the electronic devices increasingly use three-dimensional glass products. In the prior art, a glass sheet processing mold is generally employed to manufacture a three-dimensional glass product via hot-press molding, and usually includes a female die having a cavity and a male die mating with the female die; a glass sheet to be molded is clamped between the female die and the male die; at a high temperature, the male die and the female die are subjected to mold clamping and are respectively attached to the glass sheet; and after being cooled, the glass sheet can mold a three-dimensional glass product having a preset shape.

However, Inventor of the present invention has found that, based on aesthetic design and artistic pursuit, more and more three-dimensional glass products are designed with undercut structures, and a glass product having an undercut structure needs to depend on a mold having an undercut structure to achieve molding. Generally, a mold having an undercut structure also requires a slide structure, which will make design of the mold more complicated and also have more requirements for space and functions of operation machine to the disadvantage of production of a three-dimensional glass product having an undercut structure. Therefore, it is necessary to provide a new processing method and processing mold to solve the above problem.

Therefore, it is desired to provide a glass sheet processing method and a glass sheet processing mold to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a flow diagram of a glass sheet processing method according to a first embodiment of the present disclosure.

FIG. 2 is a schematic diagram showing a sectional structure before mold clamping of a first female die and a first male die of a glass sheet processing mold according to the first embodiment of the present disclosure.

FIG. 3 is an enlarged diagram of a indispensable portion A of FIG. 2.

FIG. 4 is a schematic diagram showing a sectional structure after changing mutual positions of the first female die and the first male die of FIG. 2.

FIG. 5 is a schematic diagram showing a sectional structure after mold clamping of the first female die and the first male die of FIG. 2.

FIG. 6 is an enlarged diagram of a portion B of FIG. 5.

FIG. 7 is a schematic diagram showing a sectional structure before mold clamping of a second female die and a second male die of a glass sheet processing mold according to a second embodiment of the present disclosure.

FIG. 8 is an enlarged diagram of a portion C of FIG. 7.

FIG. 9 is a schematic diagram showing a sectional structure after mold clamping of the second female die and the second male die of FIG. 7.

FIG. 10 is a schematic diagram showing a sectional structure before mold clamping of a first molding block of a glass sheet processing mold according to the second embodiment of the present disclosure.

FIG. 11 is a schematic diagram showing a sectional structure after mold clamping of the first molding block of FIG. 10.

FIG. 12 is a schematic diagram showing a sectional structure before mold clamping of a second molding block of a glass sheet processing mold according to the second embodiment of the present disclosure.

FIG. 13 is a schematic diagram showing a sectional structure after mold clamping of the second molding block of FIG. 12.

### DETAILED DESCRIPTION

The present disclosure will be hereinafter be described in detail below with reference to the attached drawings and embodiments thereof.

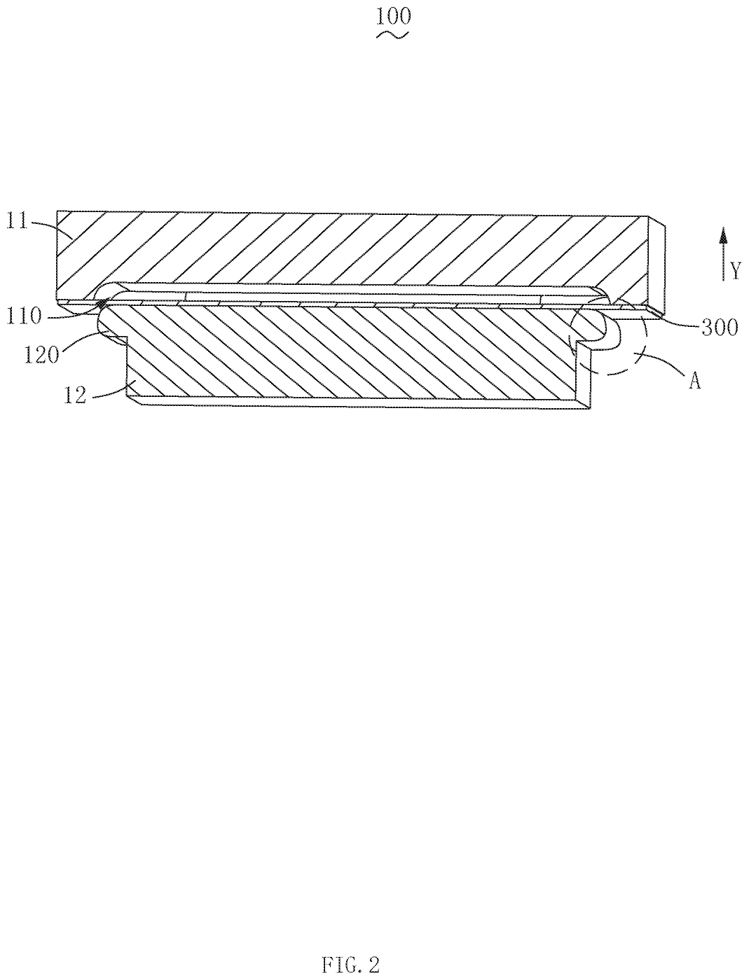

A first embodiment of the present disclosure relates to a glass sheet processing method. The core of this embodiment lies in: providing a molding mold, where the molding mold includes a first female die having a first cavity, a first male die having a first core, and a first molding block having a first undercut molding surface, a shape of the first cavity matching a shape of the first core, the first undercut molding surface being a plane or a curved surface; providing a glass sheet and hot-pressing the glass sheet to form prefabricated glass, where the prefabricated glass has a body portion, and a bent portion bending and extending from an edge of the body portion, a bending angle of the bent portion being greater than or equal to 90 degrees, the bent portion comprising a first bent portion bending in a direction away from the first core; hot-pressing the bent portion to form a second bent portion, where the first core of the first male die and the first cavity of the first female die are configured to clamp the body portion such that a remaining part of the bent portion is exposed, the first undercut molding surface of the first molding block abutting against an end portion of the bent portion, the first molding block being pushed in a first direction (the y direction in FIG. 2) from a side of the first male die toward a side of the first female die such that the first undercut molding surface presses the bent portion toward the first core of the first male die, the bent portion forming, at an end of the first bent portion, a second bent portion bending in a direction of the first core, the second bent portion being a plane or a curved surface matching the first undercut molding surface, the first direction being a mold clamping direction of the first male die toward the first female die.

In the present embodiment, prefabricated glass having a body portion and a bent portion is formed after hot-pressing a glass sheet. A first female die having a first cavity and a first male die having a first core clamp the body portion of the prefabricated glass to fix the prefabricated glass. Since the first molding block has a first undercut molding surface, the first molding block is pushed in a mold clamping direction from a side of the first male die toward the first female die such that the first undercut molding surface presses the bent portion toward the first core of the male die. Where the first undercut molding surface and the first core surface are pressed against each other, an end of the first bent portion of the prefabricated glass forms a second bent portion. The second bent portion is an undercut structure being in the shape of a flat plate or a curved surface and bending in the direction of the first core. With respect to the manner of using a mold having a slide structure, the structural design of the mold used in this processing manner is relatively simple and there are relatively low requirements for space and functions of operation machine, which can easily and rapidly mold a three-dimensional glass product having an undercut structure.

Implementation details of the glass sheet processing method of the present embodiment will be specifically described below. The following contents are intended merely to facilitate understanding of the implementation details provided, and are not indispensable for implementing the present solution.

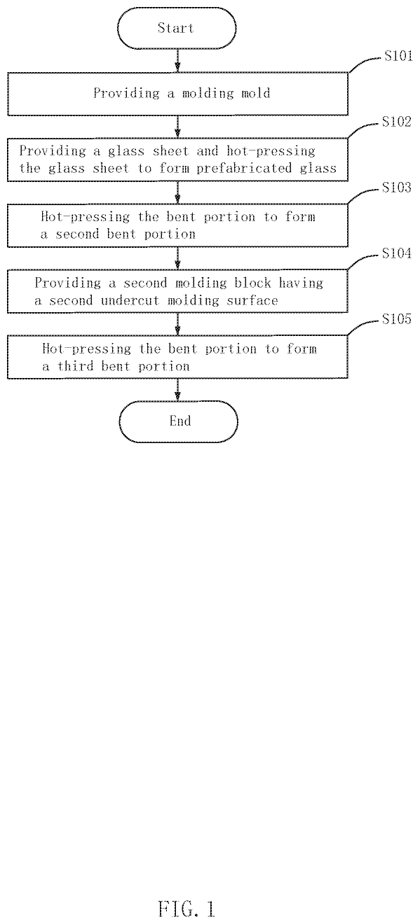

The glass sheet processing method in the present embodiment, as shown in FIG. 1, specifically includes the following.

Step 101: providing a molding mold.

Specifically, the molding mold includes a first female die 11, a first male die 12, and a first molding block 13. Therein, the first female die 11 has a first cavity 110; the first male die 12 has a first core 120; and the first molding block 13 has a first undercut molding surface 131. A shape of the first cavity 110 matches a shape of the first core 120. The first core 120 of the first male die 12 can extend into the first cavity 110 of the female die 11 to achieve mold clamping. The first core 120 of the first male die 12 can also be taken out from the first cavity 110 of the first female die 11 to achieve mold parting. In addition, the first undercut molding surface 131 is a plane or a curved surface (which may also be an arc surface). It can be understood that provision of a molding tool is prepared for subsequently hot-pressing a glass sheet 300 by using the first male die 12 and the first female die 11.

Step 102: providing a glass sheet and hot-pressing the glass sheet to form prefabricated glass.

Specifically, prefabricated glass 200 has a body portion 21 and a bent portion 22. Therein, the bent portion 22 bends and extends from an edge of the body portion 21. In the present embodiment, the body portion 21 has a flat shape; a bending angle of the bent portion 22 is greater than or equal to 90 degrees; and the bent portion 22 includes a first bent portion 221 bending in a direction away from the first core 120. It is worth noting that, in the present embodiment, the bending angle of the bent portion 11 is preferably a fillet according to design of the glass product, where the fillet is greater than or equal to 90 degrees. The fillet, as compared with a sharp structure, contributes to dispersing external forces, that is, configuration of the fillet can enhance stress capabilities of the prefabricated glass 200 itself. It is worth noting that, in the present embodiment, the “edge” may refer to an entire surrounding/circumferential edge, or may refer to a partial edge (such as two sides), without any limitation set herein.

It could be understood that, the above listing regarding shapes and angles is only an embodiment, and does not constitute a limitation of the present solution in other embodiments. In other embodiments, other shapes or specific angles are also possible, and are not listed herein for description.

Further, in the hot-pressing process of the prefabricated glass 200, it is possible to mold, via hot-pressing, the prefabricated glass 200 by means of the first male die 12 and the first female die 11 in the present embodiment, which will be introduced below.

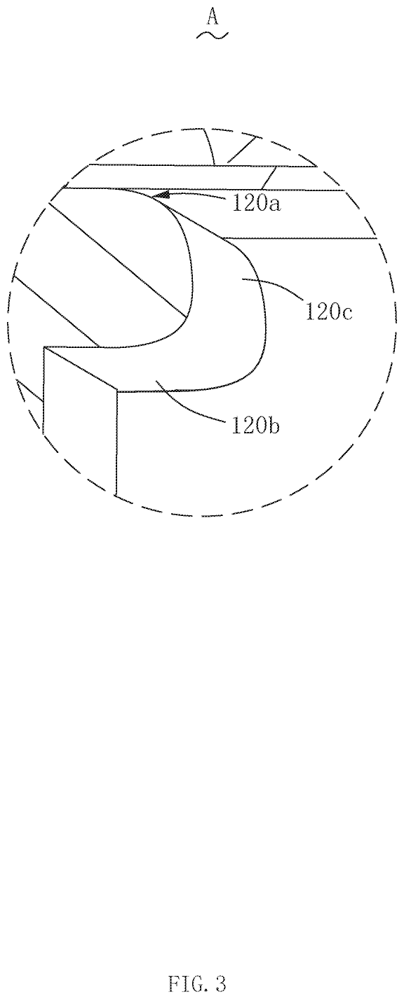

When the prefabricated glass 200 is formed by hot-pressing the glass sheet 300 via the first male die 12 and the first female die 11, the first core 120 further includes a top surface 120a oriented toward the first cavity 110, a bottom surface 120b away from the first cavity 110, and a side surface 120c disposed at an edge of the top surface 120a and extending from the top surface 120a toward the bottom surface 120b (for the sake of better understanding, refer to FIG. 2 and FIG. 3 in the second embodiment at the same time). In the present embodiment, the side surface 120c may be a plane, and may also be an arc surface protruding in a direction away from a central axis of the first core 120. The present embodiment adopts an arc surface, and it could be understood that this is only an embodiment and does not constitute a limitation of the present solution in other embodiments. The shape of the first cavity 110 still matches the shape of the first core 120. It should be noted that, the side surface 120c is shaped with respect to the sections/profiles shown in FIG. 2 and FIG. 3. In other words, that the side surface 120c is a plane means that the side surface 120c is embodied as a straight line in the section/profile; and that the side surface 120c is a curved surface means that the side surface 120c is embodied as an arc line/curve line in the section/profile. As a matter of fact, as long as the side surface 120c with a steric structure is made a section/profile in the direction as shown in the Figure, the section line/profile line is a straight line, or an arc line/curve line, all falling within the protection scope of the present solution. This explanation is also applicable to the following descriptions and other embodiments. In order to avoid repetition, no details are described herein.

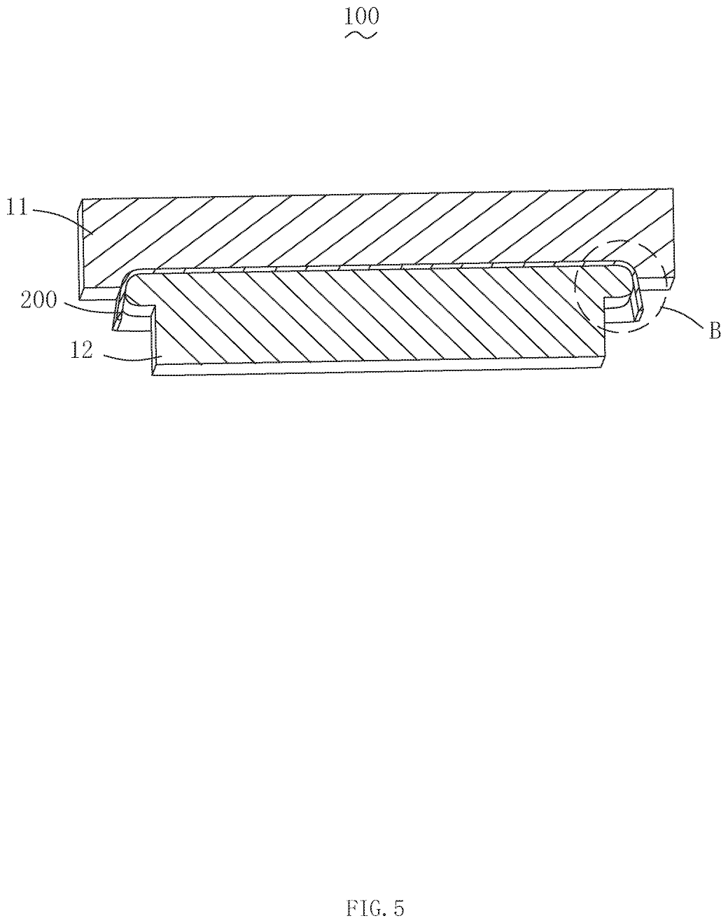

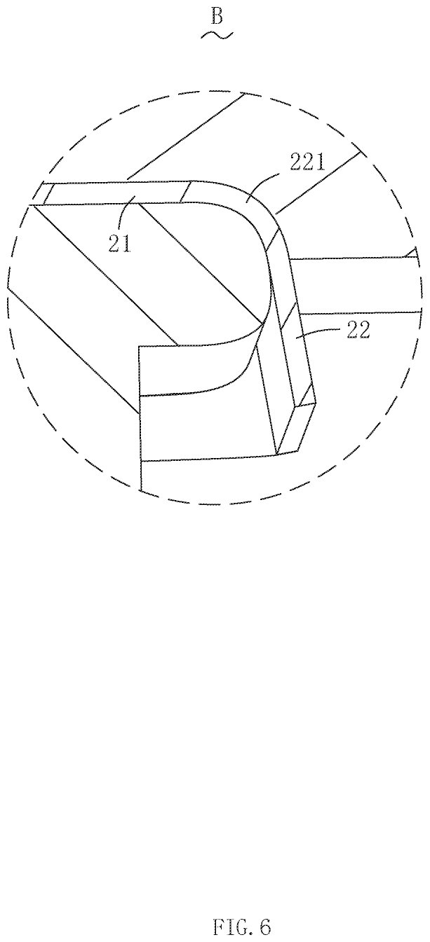

At this time, the method specifically includes the following steps: supporting a central position of the glass sheet 300 with the first core 120 of the first male die 12; configuring the first cavity 110 of the first female die 11 to directly face the first core 120; and hot-pressing, via the first female die 11, the edge of the glass sheet 300 in a direction adjacent to the first male die 12 to form the first bent portion 221, as shown in FIG. 5 and FIG. 6. As such, prefabrication and subsequent molding of a glass product can be completed by using only one set of male and female dies, which, as compared with the manner of using multiple sets of tools, reduces a complicated process formed by the use of multiple sets of tools and avoids the complicated working procedures during replacement of the multiple sets of tools, thereby facilitating production of the glass product and making it possible to further improve production efficiency.

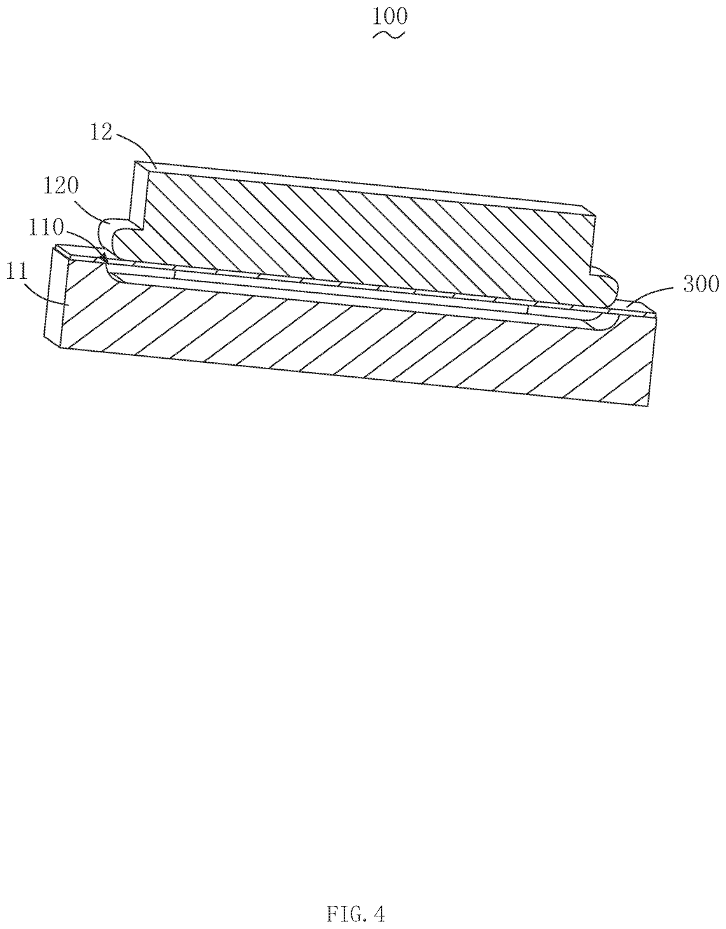

It is worth noting that, when the prefabricated glass 200 is molded by using the first male die 12 and the first female die 11, positions of the first male die 12 and the first female die 11 can be selected as required. For example, the first male die 12 is placed on the upper side and the first female die 11 is placed on the lower side (see FIG. 4 in the second embodiment); alternatively, the first male die 12 is placed on the lower side and the first female die 11 is placed on the upper side (see FIG. 2 in the second embodiment), without any limitations set herein.

Step 103: hot-pressing the bent portion to form a second bent portion.

Specifically, in this step, the first core 120 of the male die 12 and the first cavity 110 of the first female die 11 are first used to clamp the body portion 21 and a part of the bent portion 22, such that a remaining part of the bent portion 22 is exposed. The first undercut molding surface 131 of the first molding block 13 abuts against an end portion of the bent portion 22, and the first molding block 13 is pushed in a first direction (a direction indicated by an arrow y in FIG. 2) from a side of the male die 12 toward a side of the first female die 11 such that the first undercut molding surface 131 presses the bent portion 22 toward the first core 120 of the first male die 12. The bent portion 22 forms, at an end of the first bent portion 221, a second bent portion 222 bending in the direction of the first core 120. The second bent portion 222 is a plane or curved surface matching the first undercut molding surface 131. Therein, the first direction is a mold clamping direction of the first male die toward the first female die. The second bent portion 222 is an undercut structure, which may be referred to as a first undercut structure in the present embodiment. The first undercut molding surface 131 is configured to mold an undercut shape of the first undercut structure. Therefore, according to a need for appearance of the undercut structure, it is possible to select a first molding block 13 having a corresponding undercut molding surface, or manufacture a first molding block 13 having a corresponding undercut molding surface.

It is worth noting that, when the first male die 12 and the first female die 11 are configured to clamp the body portion 21, the positions of the first male die 12 and the first female die 11 can also be selected as required. For example, the first male die 12 is above the first female die 11, or the first die 12 is below the first female die 11, without any limitations set herein.

Step 104: providing a second molding block having a second undercut molding surface.

In other words, after the first molding block 13 is configured to hot-press the bent portion 22 of the prefabricated glass 200, a second molding block 16 can be further provided in the present embodiment. The second molding block 16 has a second undercut molding surface 161 for being clamped into a third bent portion 223. The second undercut molding surface 161 is a curved surface concave in a direction away from the first core 120. A bending degree of the second undercut molding surface 161 is greater than that of the first undercut molding surface 131. It should be noted that, “small bending degree” refers to “gentler”. That is, the first undercut molding surface 131 is gentler than the second undercut molding surface 161.

It is worth noting that, the second undercut molding surface 161 can mold an undercut shape of the third bent portion 223 (that is, the second undercut structure). Therefore, according to a need for appearance of the undercut structure, it is possible to select a second molding block 16 having a corresponding undercut molding surface, or manufacture a second molding block 13 having a corresponding undercut molding surface.

Step 105: hot-pressing the bent portion to form a third bent portion.

Specifically, in this step, the first core 120 of the male die 12 and the first cavity 110 of the first female die 11 are used to clamp the body portion 21 and a part of the bent portion 22, such that a remaining part of the bent portion 22 is exposed. The second undercut molding surface 161 of the second molding block 13 abuts against the end portion of the bent portion 22, and the second molding block 16 is pushed in a first direction from a side of the first male die 12 toward a side of the first female die 11 such that the second undercut molding surface 161 of the second molding block 16 presses an edge of the bent portion 22 toward the first core 120 of the first male die 12. The bent portion 22 forms, at an end of the second bent portion 222, a third bent portion 223 bending in the direction of the first core 120. The third bent portion 223 is a curved surface matching the second undercut molding surface 161, and forms a second undercut structure. It could be understood that, the third bent portion 223 has a bent shape and has a greater bending degree than the second bent portion 222. As such, a glass product with a greater undercut degree can be molded to satisfy a need for production of glass structure with a great undercut amount.

In other words, this step is further undercut conducted on the basis of the molded first undercut structure (i.e., the second bent portion). It can be understood that, when an undercut degree/undercut amount of the undercut structure needed to be hot-pressed is relatively small, the glass sheet 300 processing method in the preset embodiment can terminate in the step 103. To be opposite, since a bending degree of the second undercut molding surface 161 is greater than that of the first undercut molding surface 131, when an undercut degree/undercut amount of the undercut structure needed to be hot-pressed is relatively large, the present embodiment can preferably add the steps 104 and 105 to satisfy the structural need. When the hot-pressing effect of the first molding block 13 is inadequate, it is also possible to help hot-press the undercut structure to a desired extent via the steps 104 and 105.

In general, the present embodiment can mold three-dimensional glass having a great undercut amount via hot-pressing. In the step 102, a bending angle between the bent portion 22 and the body portion 21 of the prefabricated glass 200 formed via hot-pressing is greater than or equal to 90 degrees, and the prefabricated glass 200 is non-undercut glass. In the step 103, the side of the prefabricated glass 200 is thermally bent into an undercut bevel side or undercut curved side via the first molding block 13 which is a plane or a curved surface (or an arc surface). It should be noted that, if the undercut amount is small or the undercut end surface is of bevel design, after this step ends, it is possible to form a three-dimensional glass product having an undercut structure. For curved glass with a relatively great undercut amount, it is also necessary to hot-press the edge of the first undercut structure to a desired degree, by adding the steps 104 and 105 in this embodiment, i.e., via the second molding block 16 with a molded curved surface/arc surface.

It is worth mentioning that, since the prior art uses a slide structure to achieve mold clamping and mold opening of the undercut structure, a mold parting line easily appears in the molded product, which affects an aesthetic effect of the glass product. However, the appearance and quality of the glass formed by hot-pressing the mold with no slide design in the present embodiment are relatively good. Moreover, the hot-pressed mold in this embodiment has no slide structure, the mold design is more simple and the operation is convenient, which reduces requirements for the hot-pressing machine and processing accuracy and has excellent practical effects.

It should be noted that, in other embodiments of the present solution, specific implementation details of each step may also adopt other manners. For example, regarding “Step 102: providing a glass sheet and hot-pressing the glass sheet to form prefabricated glass”, the prefabricated glass 200 can also be molded by hot-pressing via a separately provided pre-molding mold, which will be introduced below.

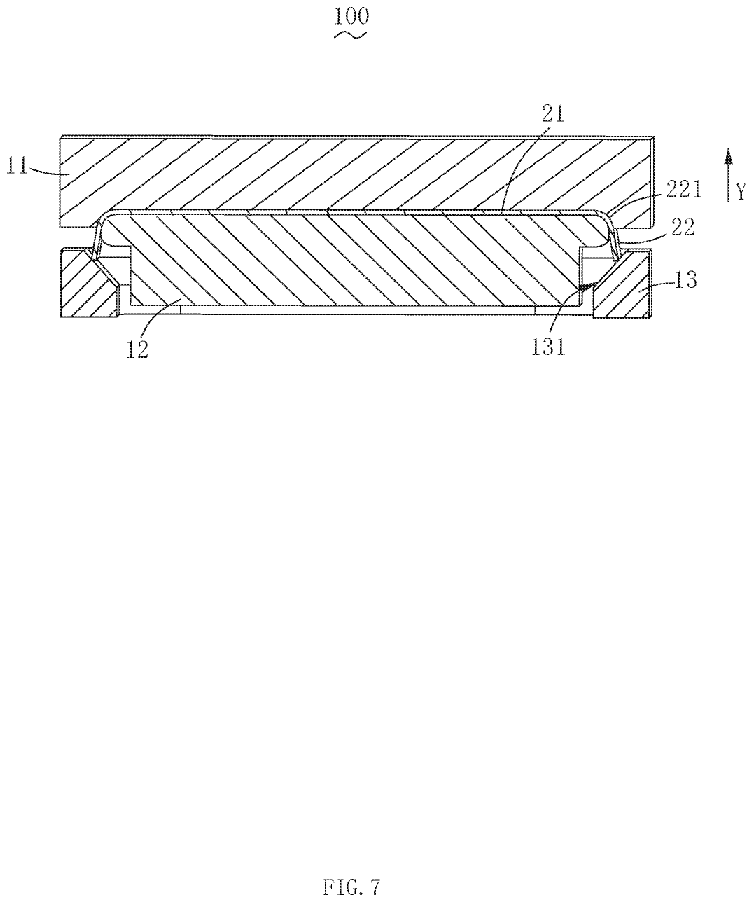

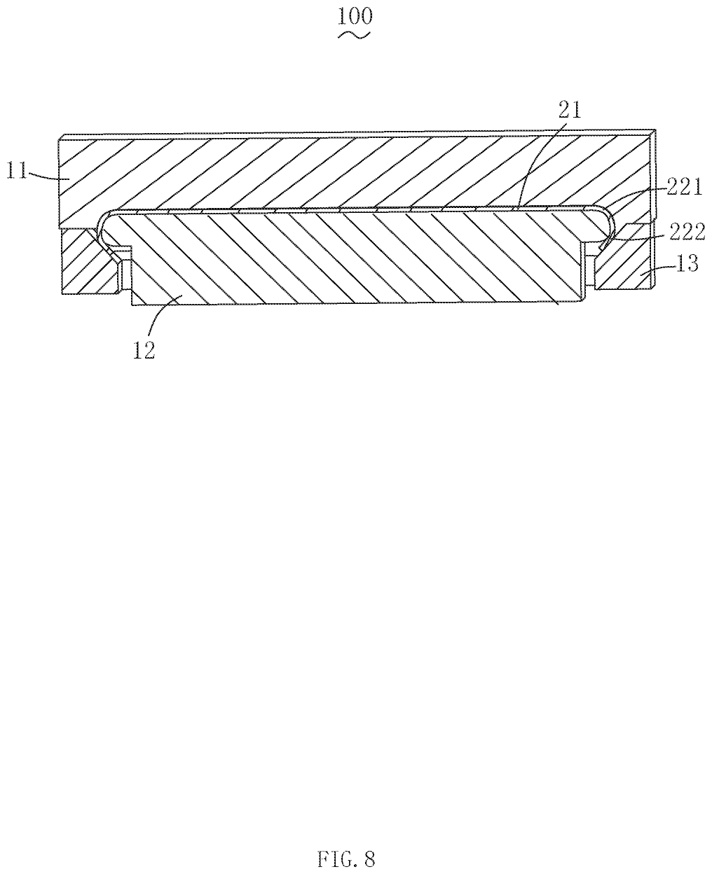

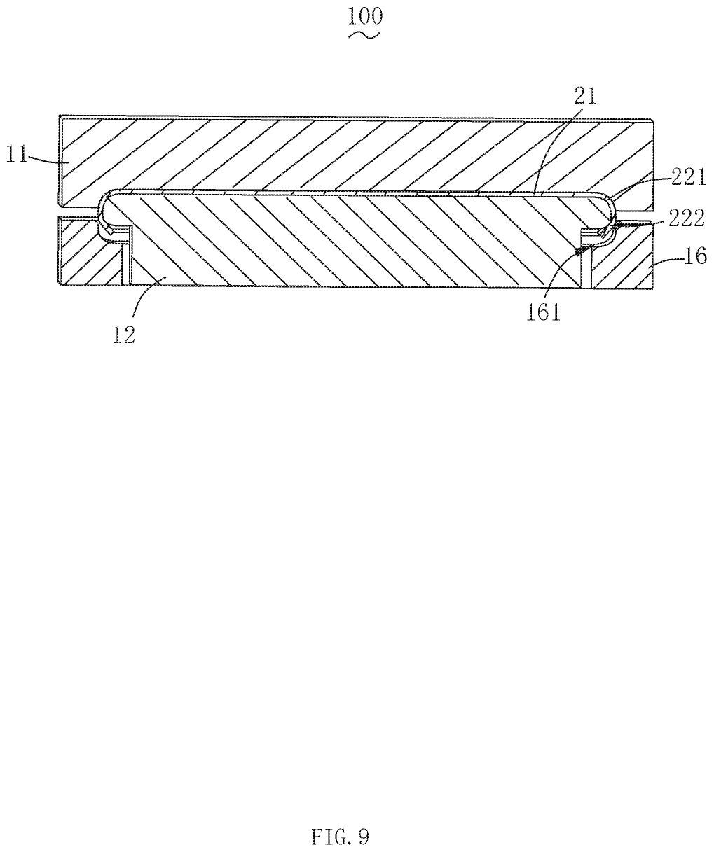

When the separately provided pre-molding mold is configured to hot-press the glass sheet 300 to form prefabricated glass 200, the pre-molding mold may include a second female die 14 having a second cavity 140 and a second male die 15 having a second core 150 (for the sake of better understanding, see FIG. 7, FIG. 8, and FIG. 9 in the second embodiment at the same time). Therein, the second male die 15 further includes a base 151 away from the second cavity 140; the second core 150 includes a top surface 150a oriented toward the second cavity 140, and a side surface 150b disposed at an edge of the top surface 150a and extending from the top surface 150a to the base in a direction away from a central axis of the second core 120. The side surface 150b is a plane, and a shape of the second cavity 140 matches a shape of the second core 150. At this time, the process of hot-pressing the prefabricated glass 200 specifically includes the following steps: providing a pre-molding mold and supporting a central position of the glass sheet 300 with the second core 150 of the second male die 15; configuring the second cavity 140 of the second female die 14 to directly face the second core 150; and hot-pressing, via the second female die 14, an edge of the glass sheet 300 in a direction adjacent to the second male die 15, to form the first bent portion 221. The structures of the second male die 15 having the top surface 150a and the side surface 150b and the second female die 14 mating therewith are relatively simple. As such, a simple and ordinary female die and male die can be used as the second female die 14 and the second male die 15 to complete the process of prefabricating the glass sheet 300, thereby reducing requirements for the template structure in the hot-press prefabrication process of the glass sheet 300.

It is worth mentioning that, when the second male die 15 and the second female die 14 are configured to mold the prefabricated glass 200, positions of the second male die 15 and the second female die 14 can be selected as required. For example, the second male die 15 is placed on the upper side and the second female die 14 is placed on the lower side; alternatively, the second male die 15 is placed on the lower side and the second female die 14 is placed on the upper side, without any limitations set herein.

A second embodiment of the present disclosure relates to a glass sheet processing mold 100, as shown in FIGS. 2-13, and the present embodiment is a glass sheet processing mold 100 corresponding to the glass sheet processing method in the first embodiment.

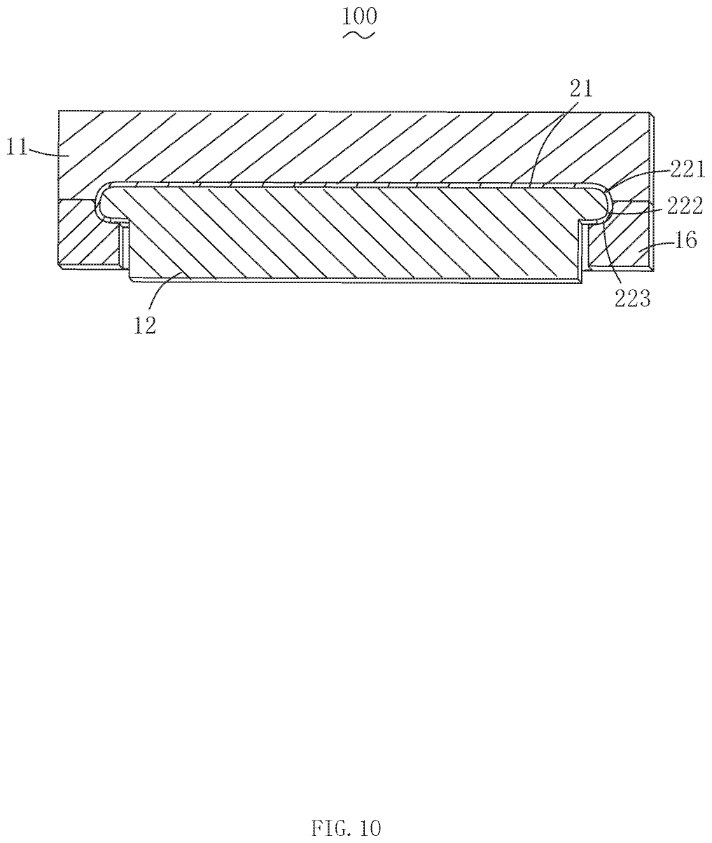

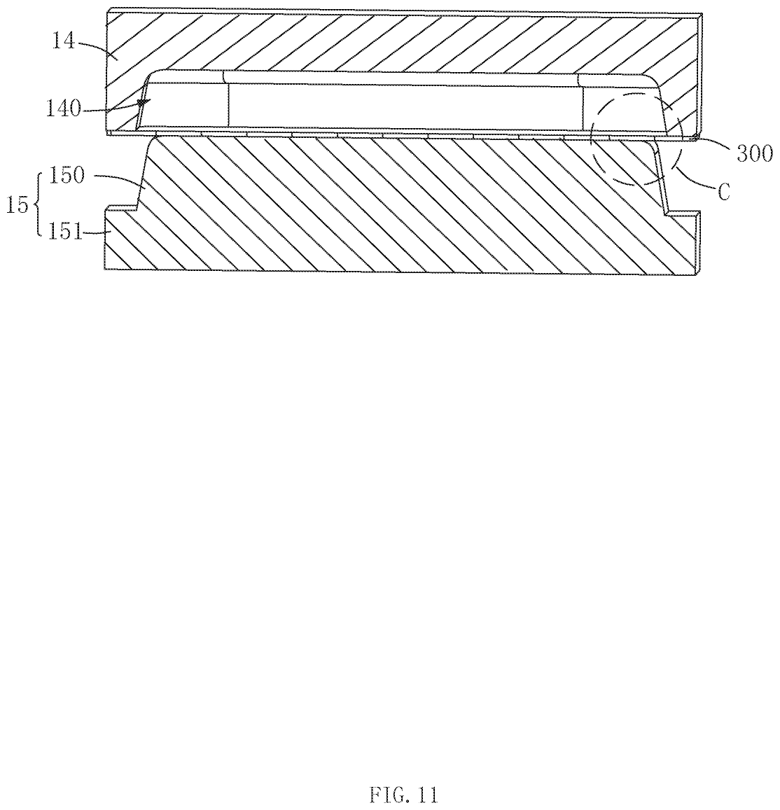

The glass sheet processing mold 100 includes a first female die 11 having a first cavity 110, and a first male die 12 having a first core 120. A shape of the first cavity 110 matches a shape of the first core 120. The glass sheet processing mold 100 further includes a first molding block 13 having a first undercut molding surface 131 which is a plane or a curved surface, as shown in FIG. 10. The first molding block 13 is configured to hot-press prefabricated glass 200. The prefabricated glass 200 has a body portion 21, and a bent portion 22 bending and extending from an edge of the body portion 21. A bending angle of the bent portion 21 is greater than or equal to 90 degrees. The bent portion 22 includes a first bent portion 221 bending in a direction away from the first core 120. The first core 120 of the first male die 12 and the first cavity 110 of the first female die 11 are configured to clamp the body portion 21 and a part of the bent portion 22 such that a remaining part of the bent portion is exposed. The first undercut molding surface 131 of the first molding block 13 is configured to abut against an end portion of the bent portion 22, and the first molding block 13 is pushed in a first direction (a y direction as shown in FIG. 2) from a side of the first male die 12 toward a side of the first female die 11 such that the first undercut molding surface 131 presses the bent portion 22 toward the first core 120 of the first male die 12. The bent portion 22 forms, at an end of the first bent portion 221, a second bent portion 222 bending in a direction of the first core 120. As shown in FIG. 11, the second bent portion 222 is a plane or a curved surface matching the first undercut molding surface 131. The first direction is a mold clamping direction of the first male die 12 and the first female die 11.

In the present embodiment, the glass sheet processing mold 100 can clamp the body portion 21 and a part of the bent portion 22 of the prefabricated glass 200 via the first female die 11 and the first male die 12, and form, via hot-pressing, a second bent portion 221 at an end of the first bent portion 221 of the bent portion 22 via the first undercut molding surface 131 of the first molding block 13, i.e., an undercut structure is molded. With respect to a mold having a slide structure, the present embodiment can complete molding of the undercut structure simply by use of the female die, the male die and the first molding block 13, where the mold structure and mold design are more simple, there are relatively low requirements for space and functions of the operation platform and the use is also more convenient.

Implementation details of the present embodiment will be specifically described below. The following contents are intended merely to facilitate understanding of the implementation details provided, and are not indispensable for implementing the present solution.

In the present embodiment, the glass sheet processing mold 100 includes a first female die 11, a first male die 12, a first molding block 13, and a second molding block 16.

The first female die 11 has a first cavity 110, and the first male die 12 has a first core 120. Therein, the first core 120 mates with the first cavity 110. Specifically, the first core 120 can extend into the first cavity 110 of the first female die 11, and can also be removed from the first cavity 110 of the first female die 11 to achieve mold clamping and mold opening of the first female die 11 and the first male die 12, respectively. It is worth mentioning that, the first female die 11 can be placed above the first male die 12, as shown in FIG. 2; and the first female die 11 can be placed below the first male die 12, as shown in FIG. 4, without any limitations set herein. It is possible to make a selection according to actual circumstances.

In the present embodiment, the first female die 11 and the first male die 12 are configured to clamp prefabricated glass 200. Therein, the prefabricated glass 200 includes a body portion 21 and a bent portion 22 bending and extending from an edge of the body portion 21. A bending angle of the bent portion 22 is greater than or equal to 90 degrees, and the bent portion 22 includes a first bent portion 221 bending in a direction away from the first core 120. Specifically, the first core 120 and the first cavity 110 are configured to clamp the body portion 21 and a part of the bent portion 22, and to expose a remaining part of the bent portion 22 for subsequent processing. It should be noted that, in the present embodiment, the “edge” may refer to an entire surrounding/circumferential edge, or may also refer to as a partial edge (such as two sides), without any limitations set herein.

The first molding block 13 is configured to mate with the first core 120 of the first male die 12, and the second bent portion 22 is formed via hot-pressing on the prefabricated glass 200, as shown in FIGS. 10 and 11. The first molding block 13 further includes a first undercut molding surface 131 for molding the second bent portion 222.

In the present embodiment, the first molding block 13 is disposed on a side of the first male die 12 with respect to the first female die 11. Specifically, the first molding block 13 is disposed on a periphery of the first male die 12. Therein, the first undercut molding surface 131 of the first molding block 13 is configured to abut against an end portion of the bent portion 22, and the first molding block 13 is pushed in a first direction from a side of the first male die 12 toward a side of the first female die 12 such that the first undercut molding surface 131 presses the bent portion 22 toward the first core 120 of the first male die 12. As such, the bent portion 22 forms, at an end of the first bent portion 221, a second bent portion 222 bending in the direction of the first core 120.

It should be noted that, in the present embodiment, the first undercut molding surface 131 is a plane or a curved surface (or an arc surface). Therefore, the second bent portion 222 molded via the first undercut molding surface 131 is also in the shape of a plane or a curved surface (or in the shape of an arc surface). In the present embodiment, the second bent portion 222 is in the shape of a flat plate or a curve that is inclined toward the first core 120. For details, see FIG. 11. As such, the second bent portion 222 having an inclined plane or an inclined curved surface can be formed by hot-pressing via the first undercut molding surface 131 in the shape of a plane or a curved surface, that is, the first undercut structure of the glass product is molded, thereby making it possible to satisfy a need for molding of the glass product. It could be understood that the above description is only a preferred embodiment and does not constitute a limitation of the present solution in other embodiments. For example, in other embodiments, the first undercut molding surface 131 may also have other shapes, without being enumerated herein.

It could be understood that, there are many manners of prefabricating glass, including prefabrication hot-pressing via the first female die 11 and the first male die 12. Specifically, the first core 120 includes a top surface 120a oriented toward the first cavity 110, a bottom surface 120b opposite to the top surface 120a and away from the first cavity 110, and a side surface 120c disposed at an edge of the top surface 120a and extending from the top surface 120a toward the bottom surface 120b. The side surface 120c is an arc surface protruding in a direction away from a central axis of the first core 120. A shape of the first cavity 110 matches a shape of the first core 120. The top surface 120a and the side surface 120c are configured to hot-press, together with the first cavity 110, the glass sheet 300 to mold prefabricated glass 200 having the first bent portion 221, as shown in FIG. 6. Thus, prefabrication and molding of the glass product can be completed by using only one set of male and female dies (i.e., the first male die 12 and the first female die 11), which, as compared with the manner of using multiple sets of tools, reduces a complicated process formed by the use of multiple sets of tools and avoids the complicated working procedures during replacement of the multiple sets of tools, thereby facilitating production of the glass product and making it possible to further improve production efficiency.

In the present embodiment, an included angle formed at a connection between the top surface 120a and the side surface 120c is greater than or equal to 90 degrees, that is, the included angle is an obtuse angle or a right angle. In addition, in the present embodiment, the included angle is preferably fillet such that a bending angle of the bent portion 22 of the prefabricated glass 200 is greater than or equal to 90 degrees and the bending angle is made a fillet. The fillet, as compared with a sharp structure, contributes to dispersing external forces, that is, configuration of the fillet can enhance stress capabilities of the prefabricated glass 200 itself.

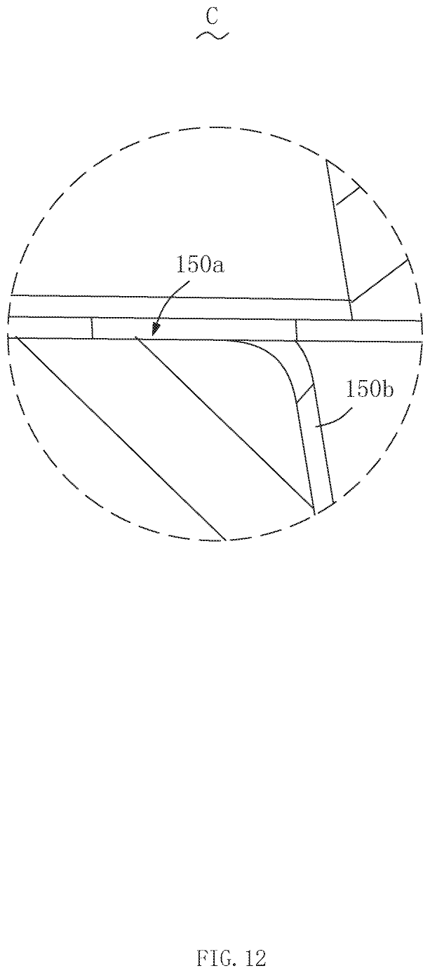

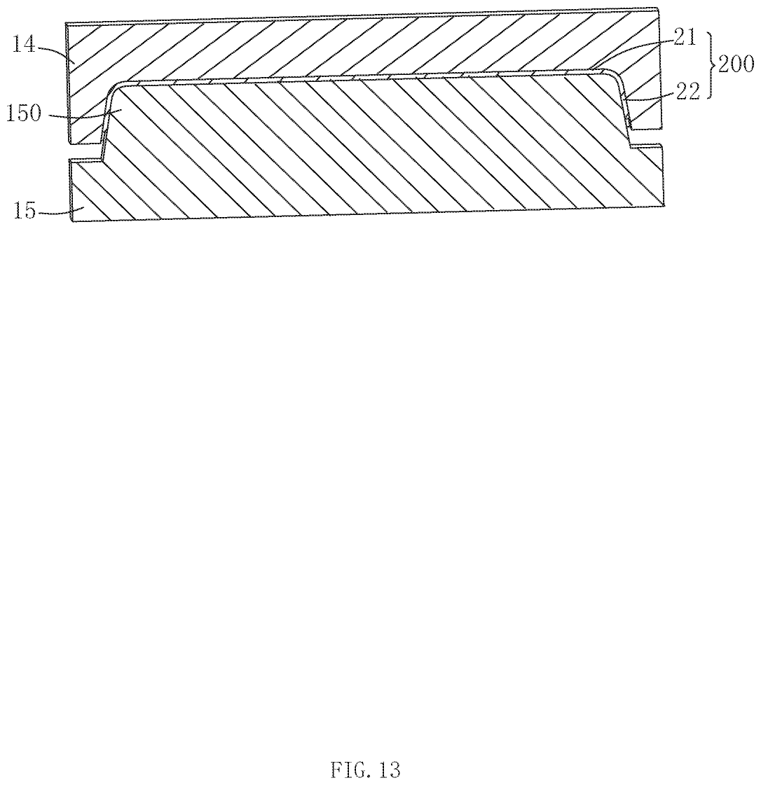

The second molding block 16 has a second undercut molding surface 161. As shown in FIGS. 12 and 13, the second molding block 16 is configured to mate with the first core 120 of the first male die 12 and to further process the bent portion 22, so as to mold a third bent portion 223, i.e., a second undercut structure, at an end of the second bent portion 22.

Specifically, the second undercut molding surface 161 hot-presses a peripheral end of the second bent portion 222 to mold the third bent portion 223. As shown in FIGS. 12 and 13, the molded third bent portion 223 bends in a direction of the core 120. In the present embodiment, the second undercut molding surface 161 of the second molding block 16 is preferably a curved surface/arc surface concave in a direction away from the first core 120. A bending degree of the second undercut molding surface 161 is greater than that of the first undercut molding surface 131. Thus, the third bent portion 223 formed via hot-pressing is a curved surface/arc surface matching the second undercut molding surface, which satisfies a need for the structure of the glass product. In the present embodiment, a bending degree of the second undercut molding surface 161 is greater than that of the first undercut molding surface 131, that is, the first undercut molding surface 131 is gentler than the second undercut molding surface 161. Thus, as compared with the first molding block 13, the second molding block 16 can produce an undercut structure with a greater undercut amount. In addition, if the first molding block 13 fails to press the second bent portion 222 in place, it is also possible to additionally press in place by means of the second molding block 16. Of course, when an undercut amount of the undercut structure required for the glass product is relatively small, the third bent portion 223 may also be molded without using the second molding block 16, and the second bent portion 222 may be molded by using only the first molding block 13. It could be understood that the above description is only a preferred embodiment and does not constitute a limitation of the present solution in other embodiments. For example, in other embodiments, the second undercut molding surface 161 may also have other shapes, without being enumerated herein.

It should be noted that there are many manners of producing prefabricated glass 200. In other embodiments of the present solution, in addition to prefabrication hot-pressing via the first female die 11 and the first male die 12, it is also possible to prefabricate and hot-press via a pre-molding mold. The pre-molding mold includes a second male die 15 and a second female die 14, as shown in FIGS. 7, 8 and 9, which will be introduced below.

Specifically, the second female die 14 and the second male die 15 can be involved in mold opening and mold clamping in a mutually opposing manner to prefabricate and hot-press glass sheet 300 to be processed. Further, as shown in FIG. 7, FIG. 8 and FIG. 9, in the present embodiment, the second female die 14 includes a second cavity 140; the second male die 15 includes a second core 150; and the second male die 15 further includes a base 151 away from the second cavity 140. The second core 150 includes a top surface 150a oriented toward the second cavity 140, and a side surface 150b disposed at an edge of the top surface 150a and extending from the top surface 150a to the base 151 in a direction away from a central axis of the second core 150. The side surface 150b is a plane, and a shape of the second cavity 140 matches a shape of the second core 150. The structures of the second male die 15 having the top surface 150a and the side surface 150b and the second female die 14 mating therewith are relatively simple, thereby reducing requirements for the template structure in the hot-press prefabrication process of the glass sheet 300.

In the present embodiment, an included angle formed at a connection between the side surface 150b and the top surface 150 is greater than or equal to 90 degrees, that is, the included angle is an obtuse angle or a right angle. Further, in the present embodiment, the included angle is preferably a fillet such that a bending angle of the bent portion 22 of the prefabricated glass 200 is greater than or equal to 90 degrees and the bending angle is made a fillet. The fillet, as compared with a sharp structure, contributes to dispersing external forces, that is, configuration of the fillet can enhance stress capabilities of the prefabricated glass 200 itself.

It should be noted that, since the present embodiment is a processing mold adapted to the first embodiment, various details described in the first embodiment are applicable to the present embodiment, and various details described in the present embodiment are also applicable to the first embodiment. In order to avoid repetition, details are not described herein.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A glass sheet processing method, comprising:
providing a molding mold, wherein the molding mold includes a first female die having a first cavity, a first male die having a first core, and a first molding block having a first undercut molding surface, a shape of the first cavity matching a shape of the first core, the first undercut molding surface being a plane or a curved surface;
providing a glass sheet and hot-pressing the glass sheet to form prefabricated glass, wherein the prefabricated glass has a body portion, and a bent portion bending and extending from an edge of the body portion, a bending angle of the bent portion being greater than or equal to 90 degrees, the bent portion comprising a first bent portion bending in a direction away from the first core;
hot-pressing the bent portion to form a second bent portion, wherein the first core of the first male die and the first cavity of the first female die clamp the body portion and a part of the bent portion such that a remaining part of the bent portion is exposed, the first undercut molding surface of the first molding block abutting against an end portion of the bent portion, the first molding block being pushed in a first direction from a side of the first male die toward a side of the first female die such that the first undercut molding surface presses the bent portion toward the first core of the first male die, the bent portion forming, at an end of the first bent portion, the second bent portion bending in a direction of the first core, the second bent portion being a plane or a curved surface matching the first undercut molding surface, the first direction being a mold clamping direction of the first male die and the first female die.

2. The glass sheet processing method according to claim 1, further comprising, subsequent to said hot-pressing the bent portion to form a second bent portion:
providing a second molding block having a second undercut molding surface, the second undercut molding surface being a curved surface concave in a direction away from the first core, a bending degree of the second undercut molding surface being greater than that of the first undercut molding surface;
hot-pressing the bent portion to form a third bent portion, wherein the first core of the first male die and the first cavity of the first female die are configured to clamp the body portion and a part of the bent portion such that a remaining part of the bent portion is exposed, the second undercut molding surface of the second molding block abutting against an end portion of the bent portion, the second molding block being pushed in a first direction from a side of the first male die toward a side of the first female die such that the second undercut molding surface of the second molding block presses an edge of the bent portion toward the first core of the first male die, the bent portion forming, at an end of the second bent portion, the third bent portion bending in a direction of the first core, the third bent portion being a curved surface matching the second undercut molding surface.

3. A glass sheet processing mold, comprising: a first female die having a first cavity, a male die having a first core, a shape of the first cavity matching a shape of the first core, and further comprising: a first molding block having a first undercut molding surface, the first undercut molding surface being a plane or a curved surface, the first molding block being configured to hot-press prefabricated glass, wherein the prefabricated glass has a body portion, and a bent portion bending and extending from an edge of the body portion, a bending angle of the bent portion being greater than or equal to 90 degrees, the bent portion comprising a first bent portion bending in a direction away from the first core, the first core of the first male die and the first cavity of the first female die being configured to clamp the body portion and a part of the bent portion such that a remaining part of the bent portion is exposed, the first undercut molding surface of the first molding block being configured to abut against an end portion of the bent portion, the first molding block being pushed in a first direction from a side of the first male die toward a side of the first female die such that the first undercut molding surface presses the bent portion toward the first core of the first male die, the bent portion forming, at an end of the first bent portion, the second bent portion bending in a direction of the first core, the second bent portion being a plane or a curved surface matching the first undercut molding surface, the first direction being a mold clamping direction of the first male die and the first female die.

4. The glass sheet processing mold according to claim 3, wherein the first core comprises a top surface oriented toward the first cavity, a bottom surface opposite to the top surface and away from the first cavity, and a side surface disposed at an edge of the top surface and extending from the top surface toward the bottom surface, the side surface being a plane or the side surface being an arc surface protruding in a direction away from a central axis of the first core, a shape of the first cavity matching a shape of the first core, the top surface and the side surface being configured to hot-press and mold, together with the first cavity of the first female die, prefabricated glass having the first bent portion.

5. The glass sheet processing mold according to claim 3, further comprising: a second molding block having a second undercut molding surface, the second undercut molding surface being a curved surface concave in a direction away from the first core, a bending degree of the second undercut molding surface being greater than that of the first undercut molding surface, the second molding block being configured to form, at an end of the second bent portion, a third bent portion bending in the direction of the first core, the third bent portion being a curved surface matching the second undercut molding surface.

6. The glass sheet processing mold according to claim 4, further comprising: a second molding block having a second undercut molding surface, the second undercut molding surface being a curved surface concave in a direction away from the first core, a bending degree of the second undercut molding surface being greater than that of the first undercut molding surface, the second molding block being configured to form, at an end of the second bent portion, a third bent portion bending in the direction of the first core, the third bent portion being a curved surface matching the second undercut molding surface.
